(19) United States
(12) Patent Application Publication
(10) Pub. No.: US 2026/0270646 A1
(43) Pub. Date: Sep. 10, 2026

(54) SYSTEM AND METHOD FOR MANAGING LOCATION-BASED CONTENT

(71) Applicant: Andrew Doughty, Shalimar, FL (US)

(72) Inventor: Andrew Doughty, Shalimar, FL (US)

(21) Appl. No.: 19/281,049

(22) Filed: Jul. 25, 2025

Related U.S. Application Data
(63) Continuation of application No. 19/075,101, filed on Mar. 10, 2025.

(51) Int. Cl. H04W 4/021

(52) U.S. Cl. CPC H04W 4/021

(57) ABSTRACT

A method and system may allow an operator to select a location and create a user-specific message for such location, including information on at least one access condition that must be met in order for a user to access the message. When a user fulfilling the access condition is in the location, they are presented with the user-specific message. Multiple user-specific messages for a single location may be created for different access groups. Users may be prompted to enter feedback regarding the message, which can be used for various accountability and/or analytical purposes and/or to provide updated information to users.

### CROSS-REFERENCE TO RELATED APPLICATIONS

The present applications claims the benefit of U.S. application Ser. No. 19/075,101 filed 2025-03-10, which is incorporated herein by reference.

### COPYRIGHT AND TRADEMARK STATEMENT

A portion of the present disclosure may contain material that is subject to copyright protection. The copyright owner(s) has no objection to the facsimile reproduction by anyone of the patent document or the patent disclosure as it appears in the Patent and Trademark Office patent file or records, but otherwise reserves all copyright rights whatsoever. Trademarks may be used in the present disclosure, and the applicant(s) make no claim to any trademarks referenced.

### FIELD OF THE INVENTION

The invention relates in general to the field of providing informational content to users based on their current location.

### BACKGROUND OF THE INVENTION

Applications exist for providing users with information content based on the current location of the user. A typical example is a GPS audio tour which operates in coordination with a mobile computing device such as a smart telephone, vehicle navigation system, or similar device. Such a tour application allows users to hear audio messages via the mobile device when they reach a specific location. Such messages can be extremely helpful to users because, as they drive or walk through a town, city, park, or other location, they can get helpful advice on what to see and do and be entertained by stories and legends about an area. These audio tours are mainly created by private companies and/or local government as the audio equivalent of a tour guide.

Applications exist for providing users with information content for specific locations. A typical example is a real estate mobile application which operates in coordination with a mobile computing device such as a smart telephone or similar device. Such a real estate application allows users to browse real estate by location on a map via the mobile device. Such methods of browsing real estate can be extremely helpful to users because they can find important information regarding real estate and see where it is in location to certain points of interest. These methods of delivering real estate information are mainly created by private companies as the digital equivalent to browsing a real estate portfolio.

Applications exist for communicating information content to employees for work to be done in specific locations. A typical example is an application that allows managers or supervisors to communicate information by voice and text to employees for installation or work to be performed at a job site. Such methods of relaying information to employees can be extremely helpful to users because they can provide precise information and instructions through a variety of media including images, video, text, and audio, among others, to relay information that can be reviewed as many times as is needed, even when the manager or supervisor is not available to provide information.

### SUMMARY OF THE INVENTION

Bearing in mind the problems and deficiencies of existing location-based information services, it is therefore an object of the present invention to provide a method and system that allow an operator to easily create personalized messages to communicate information to appropriate persons when such persons are in a particular location.

According to one aspect of the present disclosure, a method for managing location-based content may comprise the steps of creating a record for at least one location (such record for each location including a geographical identity of the location, an activation area, and at least one user-specific message for the location), defining at least one access condition under which each user-specific message may be to be activated for any user meeting the access condition, and then determining whether a user meeting the access condition may be located within the activation area and, responsive to such determination, presenting the user with the message for that location corresponding to the appropriate access condition.

The method may include one or more of the following features. The access condition for at least one group of users may be that the user has access to a code associated with at least one message. For a subset of messages, the step of defining at least one access condition may further comprise setting the access condition for such messages such that the message may be accessible by any user within the activation area. For at least a subset of messages, the message may have a user-specific code associated with it, and the access condition may include the condition that a user within the activation area has access to the user-specific code for that message. The user-specific messages may include audio messages and may be created by at least one technique selected from the group of recording audio of an operator delivering the message and using a computer-generation capability to convert input (such as text) entered by an operator into computer-generated audio. In the latter case, an AI capability may be employed to generate an audio message, and may clone the voice of the operator or other selected person. The method may communicate the user-specific message to at least one user device, and the step of determining whether a user meeting the access condition may be located within the activation area may be performed, at least in part, by the user device. For at least one location, the step of creating a record includes creating at least two user-specific messages for the location, and the step of defining at least one access condition may include defining an access condition for each of the user-specific messages, where at least two user-specific messages for the same location have different access conditions. The step of creating a record for at least one location may further comprise the steps of, for at least one location, identifying an authorized person associated with the location and prompting the authorized person to define at least one user-specific message for the location. The activation area may be defined in terms of both horizontal and vertical position.

The method may comprising the further steps of prompting at least one user who has been presented with a message to enter feedback regarding the message, validating feedback entered by the user, storing the validated feedback and associated message in a feedback database, and analyzing the validated feedback and associated message to perform at least one step selected from the group of providing the user with immediate feedback regarding their performance of a task related to the associated message, providing an evaluation of performance of the user regarding a task related to the associated message, and aggregating feedback and associated messages to perform at least one general analysis regarding the aggregated feedback and associated messages. The step of analyzing the validated feedback and associated message may be performed, at least partially, by an artificial intelligence capability, and may generates at least one operational insight selected from the group of worker performance metrics and safety recommendations. The method may comprise the further steps of generating an update to at least one user-specific message responsive to the step of analyzing the validated feedback and associated message, and presenting the update to at least any user meeting the access condition for the message and located within the activation area. The step of creating a record for at least one location may include defining a checkpoint area for the location with respect to at least one user, and the step of prompting at least one user to enter feedback may be performed responsive to determining when a particular user has entered their respective checkpoint area.

According to another aspect of the present disclosure, a storage medium may comprise instructions that, when executed by a processing device, executes one of the methods as described herein.

According to another aspect of the present disclosure, a system for managing location-based content may comprise a message database, at least one operator interface programmed to allow an operator to create a record in the message database for at least one location (such record for each location including geographical coordinates of the location, an activation area, at least one user-specific message for the location, and at least one access condition for each user-specific message), at least one communication channel for communicating user-specific messages to at least user devices located within the activation area of any location associated with that user-specific message, and a message manager programmed to determine whether the access condition for any user-specific message may be currently met by a user located within the activation area and, responsive to such determination, presenting the user-specific message to such user(s) via user devices located within the activation area.

The system may include one or more of the following features. For a subset of messages, the access condition for such messages may be that they are accessible by any user within the activation area. For at least a subset of messages, the message may have a user-specific code associated with it and the access condition may include the condition that a user within the activation area has access to the user-specific code for that message. The message database may store the user-specific messages as audio messages and the operator interface may be programmed to allow an operator to create such audio messages by at least one technique selected from the group of recording audio of an operator delivering the message and using a computer-generation capability to convert input entered by an operator into computer-generated audio. Computer-generated audio messages may be generated by employing an AI capability, and such AI may clone the voice of the operator or other selected person. The message database and the message manager may be provided, at least in part, by at least one application operating on a user device. The at least one operator interface may be programmed to allow an operator to create at least one record in the message database for a single location, where such record includes and a different access condition for each of at least two user-specific messages. The at least one operator interface may allow an operator to prompt at least one authorized person associated with a location to define at least one user-specific message for that location. The activation area may be defined in terms of both horizontal and vertical position.

The system may further comprise a feedback manager that prompts at least one user who has been presented with a message to enter feedback regarding the message and validates feedback entered by the user, a feedback database that stores the validated feedback and associated message, and a feedback analyzer that processes the validated feedback and associated message to provide at least one analysis product selected from the group of immediate feedback for the user with regarding their performance of a task related to the associated message, an evaluation of performance of the user regarding a task related to the associated message, and a general analysis of aggregated feedback and associated messages. The feedback analyzer may be provided, at least in part, by an AI engine, and may generate at least one operational insight selected from the group of worker performance metrics and safety recommendations. The feedback analyzer may be configured to generate an update to at least one user-specific message for presentation to at least any user meeting the access condition for the message and located within the activation area. The record for at least one location may include definition of a checkpoint area for the location with respect to at least one user, in which case the feedback manager may prompt at least one user to enter feedback responsive to determining when that user has entered their respective checkpoint area.

According to another aspect of the present disclosure, a method for managing location-based content may comprise the steps of creating a record for at least one location (such record for each location including a geographical identity of the location and an activation area), including identifying an authorized person associated with the location and prompting the authorized person to define at least one message for the location, and then determining whether an authorized user may be located within the activation area for a location and, responsive to such determination, presenting the authorized user with the message for that location. This method may include features of the methods as described above.

According to another aspect of the present disclosure, a system for managing location-based content may comprise a message database, at least one customer interface that allows a customer (subject to authorization) to define a message for at least one location associated with that customer, a location manager that controls authorization of the at least one customer interface and the association of each message with the at least one location associated with that customer, the location manager creating a record in the message database for the at least one location (such record for each location including geographical coordinates of the location, an activation area, and the message for the location defined via the associated customer interface), at least one communication channel for communicating messages to at least user devices located within the activation area of any location associated with a defined message, and a message manager programmed to determine whether a user may be located within the activation area for any defined message and, responsive to such determination, presenting the defined message to such user(s) via user devices located within the activation area. This system may include features of the systems as described above.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1A is a flow chart showing one example of an overall method for creating, storing, and publishing messages to specific users with group codes to identify if a user has permission to view such messages.

FIG. 1B is a flow chart showing one example of some steps that could be employed in a method such as shown in FIG. 1A for selecting a location, generating content for such location, and limiting access content to specific users.

FIG. 1C is a flow chart showing one example a method for presenting a user with messages depending on whether or not they have permissions to view such messages when the user approaches a location.

FIG. 1D is a flow chart showing an alternative method for presenting an appropriate user with location-based messages.

FIG. 1E is a flow chart showing one example of some steps that could be employed in a method such as shown in FIG. 1A for generating a group code and using it to limit access to content for a location.

FIG. 2 is a block diagram illustrating one example of a system for managing location-based messages for different access groups of users, to be provided to users of the appropriate access group based on the location of the user.

FIG. 3 is a flow chart showing one example of a method for allowing customers to define a message for an associated location, to be provided to authorized users when in proximity to the location.

FIG. 4 is a block diagram showing one example of a system for allowing customers to define location based messages to be presented to authorized users when in the vicinity of an associated location.

FIG. 5 is a flow chart showing one example of a method for prompting users to provide feedback responsive to location-based messages they receive.

FIG. 6 is a block diagram showing a system that includes components for receiving and analyzing feedback provided by users.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive.

Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described. Where functionalities are described for either a system or method, it should be appreciated that such description of either an application or method applies to the other, and any details of such functionality should be considered applicable to either a method or application, or to a system that employs such application and/or performs such method.

While the discussion herein describes methods and systems with reference to audio messages, in some situations other formats of information messages, such as text messages and/or graphic or video messages, might be employed in place of or in addition to audio messages.

Methods and systems for presenting location-based content on a conditional basis are described in U.S. application Ser. No. 19/075,101 filed 2025-03-10, incorporated herein by reference. In addition to conditions based on time, date, weather, road conditions, etc., as discussed in the '101 application, location-based messages can be presented to certain users conditionally based on the user's status as an appropriate recipient for the message. In this case, multiple messages may be recorded for a particular location, each intended for a different class of users.

The present method and system allow an operator to easily personalize location-based informational messages provided to specific users when the users are in a location where a particular message is appropriate. The operator can limit access to the message based on generating codes specific to a user or users and tagging such messages with user-specific codes, allowing only specified users to access such messages.

As one example of such user-specific messages, real estate agents currently show prospective homebuyers a portfolio of real estate options. Creating an audio tour of such properties would enable prospective homebuyers to review suggested real estate options at any time that is convenient to the homebuyer, and would still allow the real estate agent to prepare homebuyer-specific messages that are personalized and tailored to the homebuyer's needs. By tagging specific messages with user-specific codes, the real estate agent may identify several potential home options and points of interest in the vicinity of such homes and provide user-specific messages such that a homebuyer could view their real estate options as well as the surrounding areas on a personalized tour from their real estate agents even when the real estate agent is unavailable to show the prospective homebuyers around the neighborhood. In some cases, “preview” messages may be presented to users who are not physically present at the location, but who select the location such as by clicking a map point for the location.

As another example of such user-specific messages, a construction company may require employees from different job functions to work in the same area. Creating informational content using a variety of media that shows specific work that needs to be done with clear instructions based on user location would allow workers to have clear instructions on work they are expected to do. By tagging specific informational content with user-specific codes, the manager or supervisor may show workers across job functions instructional content that is only relevant for the user's job function, and doing so with recorded content in an application would allow for instructions to be delivered in an asynchronous format, where workers could have clear instructions regardless of whether or not a manager or supervisor is present on site for the duration of this work. In some cases, “preview” messages may be presented to users who are not physically present at the location, but who select the location such as by clicking a map point for the location. Similarly, a construction company may use a system to provide detailed directions to those delivering supplies as to how such supplies should be delivered to a worksite. In cases such as construction, the activation area for a message may be defined by both horizontal and vertical location, as similar groups of workers (welders, masons, electricians, plumbers, etc.) may have different instructions on different floors or levels of a structure.

A similar case occurs for those authorized persons who manage a particular property, which may include a property management entity, a property owner, and/or renter. Such persons may engage various service people (landscape/lawn care, house cleaners, utility workers, delivery personnel, etc.) who need instructions from the authorized person. In such cases, the method and/or system may allow an authorized person associated with a particular location to create one or more messages for that location for one or more groups of users. A similar system and/or method could be employed without group conditions such as codes, but which is only accessible to authorized users in a specific group (for example, providing delivery directions for postal carriers and package delivery personnel); in such cases the authorized access to the method/system serves to identify the user as an appropriate recipient of the message.

Showing real estate to prospective purchasers is typically a cumbersome and time-consuming process, requiring aligning schedules for both the buyer and the seller, or a representative from one or both parties. It also may not be possible to properly coordinate times to meet and review potential real estate options in a timely fashion. If a real estate agent, for example, wants to showcase a property or several properties but are unable to align their schedules with a prospective client, it may not currently be possible with existing systems and methods. It also may not be possible to provide custom messages to specific clients in a timely manner as an alternative to aligning the agents' and clients' schedules.

Providing instructions to workers is typically a cumbersome and time-consuming process, requiring alignment across schedules for both the worker and manager. It also may not be possible to properly coordinate times to meet and review potential work to be done in a timely fashion. If a manager wants to provide instructions on work to several different groups of employees on the same job site, it may not currently be possible with existing systems and methods.

The content management method and system disclosed herein have features that allow an operator to readily prepare custom, user-specific messages for a location or group of locations. For a particular location, one or more messages may be stored, such as in a message database, of which any can be tagged using a code that is specific to a user or group of users. For audio messages, the message(s) could be created by the operator recording the audio and/or by the operator entering text (or other relevant input) for each message and using a generative AI capability to automatically convert the text to an audio by an AI-cloned voice. The voice-generation capability may use cloning to match the generated audio to the voice of the operator to provide personalized messages to users. Once created, the message may be reviewed and, once approved, imported into the record and saved on a server (such as in a message database stored on such server). The messages can then be received from the server by the GPS-enabled app to be played at specific locations, with the message presented to specific users in that location, based on the user(s) device(s) meeting the condition that they have entered or otherwise have access to the user-specific code prepared by the operator. The messages may be stored on the server and accessed as appropriate and/or may be stored locally on an application run by a user device (which can allow user-specific messages to be presented at the appropriate time without being dependent on the user device being able to access the server). Where messages are stored locally on a user device, the messages to be stored are typically only those messages matching the user's access condition(s) or code(s). To further reduce storage requirements, the messages to be stored locally may be a subset defined by criteria such as geography, user stored itinerary, user interests (such as for real estate listings), user current work assignments, etc. For example, only messages associated with locations with the user's state/province/region could be stored, only messages for locations within a specified distance (as determined by geographical distance and/or travel time) of the user current location (to be periodically updated) could be stored, only messages for locations matching a stored user itinerary could be stored, etc.

As one example, the user-specific message may be related to a specific property the operator intends to show a prospective real estate client. The operator may generate a code in one portion of the content management system, then enter such code into the content management system record for that specific real estate property. By entering this code into the record for the property in question, the operator may limit the number of users who may review this message only to users who have entered this code into their device's application.

The operator may provide this code to the specific users they want to review these messages. The user, upon inputting the specific code provided to them by the operator in the application on their device will be provided access to review these messages. Such user-specific messages can be stored locally on the permitted user(s) device(s) and activated for presentation when the user is ready, including when they are present at the location in question and when using a “preview” of the message while not physically present at the location in question.

As another example, the user-specific message may be related to a specific property the operator intends to have workers perform work on. The operator may generate a code in one portion of the content management system, then enter such code into the content management system record for specific groups of workers that will be working on the property. This could include painters, landscapers, roofers, plumbers, and other workers. By entering this code into the record for the property in question, the operator may limit the number of users who may review this message only to intended recipients of the informational content related to their specific job function. The operator may provide this code to the specific users they want to review these messages to enter into their apps. Alternatively, they may associate such group codes directly with the user, providing the user with access to review these messages. Such user-specific messages can be stored locally on the permitted user(s) device(s) and activated for presentation when the user is ready, including when they are present at the location in question and when using a “preview” of the message while not physically present at the location in question.

As an example of how the method and/or system could operate, consider a real estate agent who has several real estate options for a prospective client or several prospective clients. The real estate agent may wish to show both the specific property or properties that prospective buyers may wish to purchase, as well as points of interest in the neighborhood and areas surrounding these real estate options. The real estate agent can generate a code, apply it to specific real estate records and records for points of interest, allowing them to record or generate custom audio specific to the prospective buyers. Then, whenever the prospective buyer(s) is/are in the area, the prospective buyer could review the real estate agent's messages as if they were participating in a regular tour of the area, but without the need for all parties to be present. Optionally, such messages could also be presented to users located outside the area if they select the particular location on an app, such as by clicking on a map point displayed on a user device. Such messages could be pulled from a centralized server at the time and/or could be stored locally on the specified user's device. Creating codes for different individual buyers or groups of buyers may allow filtering information to suit different groups, such as providing information on local schools only to families or prospective future parents, but not to elderly buyers.

As an example of how the method and/or system could operate, consider a construction company manager who is currently organizing a team across several labor functions to build a house. The manager may wish to provide information to several teams that will be working in similar areas of the house or grounds, including in the same room. The manager can generate several codes representing access for various groups, and apply them to specific informational records, allowing the manager to record or generate custom audio specific to the job function of the intended worker. Then, whenever the worker(s) is/are in the area, the worker(s) could review the manager's messages as instructions for work that needs to be performed, but without the need for all parties to be present. Additionally, this would allow several workers across multiple job functions to each receive information related to their job function without receiving instructions for work outside of their job function. Optionally, such messages could also be presented to users located outside the area if they select the particular location on an app, such as by clicking on a map point displayed on a user device. Such messages could be pulled from a centralized server at the time and/or could be stored locally on the specified user's device. Particularly in the case of construction, the activation area may include vertical location, allowing for specific messages for users on different floors or levels of a structure.

The method and/or system may allow for certain messages to be available to all users by entering a “global” code that applies to every user with access to the application or to one section of the application.

The method and/or system may allow for more than one user-specific audio message to be associated with one or more locations. Some records may have a message that is available to all users, with alternate messages available to specific users that supersede the “global” message when a specified user is reviewing the message for the associated record.

The ability to be able to provide custom messages to specified users brings great convenience to operators/administrators of such real estate applications and becomes very attractive to real estate agents, companies, and other professionals who want to be able to provide custom information to prospective buyers and clients, and change the message presented to users within a location or group of locations as they see fit.

When operating, such apps may be set to silence whatever music or news a driver or other user is listening to play on the speakers of a device or vehicle. When an audio message is activated, the app could stop the music or other audio program playing, deliver the message, then turn the audio program back on. In some cases, whether or not to interrupt the current audio program could be a part of the activation criteria recorded for a particular message.

The ability to be able to provide custom messages to specified users brings great convenience to operators/administrators of such work information applications and becomes very attractive to managers, companies, and other professionals who want to be able to provide custom information to workers and contractors, and change the message presented to users within a location or group of locations as they see fit. Such apps may be set to silence whatever music or news the worker is listening to play on the speakers. When an audio message is activated, the app could stop the music or other audio program playing, deliver the message, then turn the audio program back on. In some cases, whether or not to interrupt the current audio program could be a part of the activation criteria recorded for a particular message.

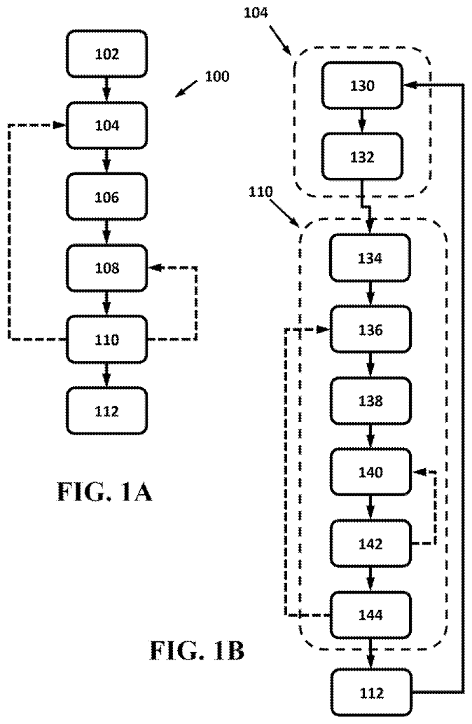

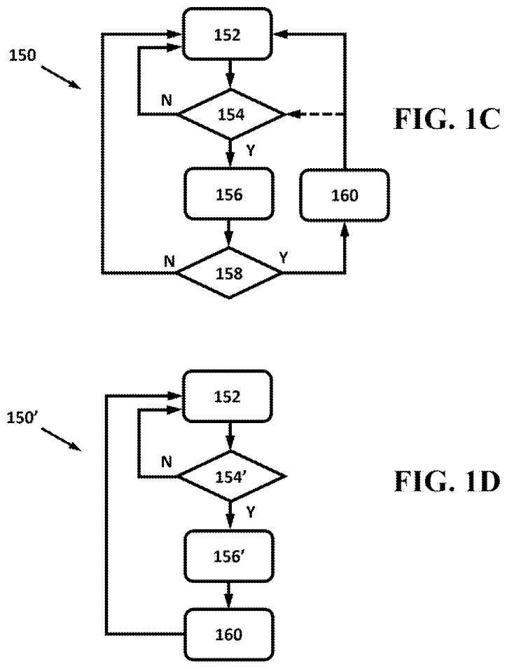

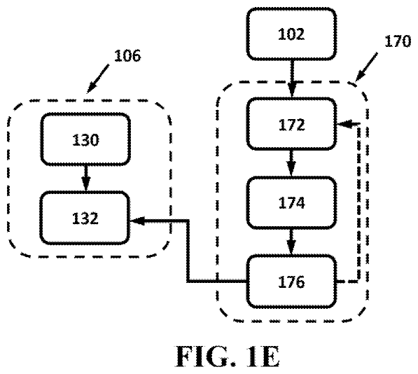

FIGS. 1A-1E are flow charts illustrating examples of a methods for creating location-based user-specific messages and presenting such messages to appropriate users when at a location. The method can be broadly broken into a method or routine 100 for an operator to create user-specific message records for one or more locations, a method or routine 150 for presenting appropriate messages to a user, a method or routine 170 for creating custom codes to identify messages intended for specific users, and a method or routine 250 for generating codes and assigning them to groups of users.

Referring to FIG. 1A, the method 100 may start with the operator logging into a system (step 102); such step may include conventional security and/or account management features to limit access to authorized personnel. The login credentials of the operator entered in step 102 may define what area of locations the user is authorized to enter records for, when the method is employed by operators having differing ranges of authorities (such as multiple different real estate agents or construction companies using a single application). In some cases, common information may be applicable to multiple operators, such as real estate information on common factors (such as information on schools or public facilities in a particular area in which multiple real estate operators are using the method/system or road conditions relevant to a particular location where multiple construction companies are using the method/system). For simplicity, the method and system are discussed with respect to a single range of authority and operator.

Once logged in, the operator can select a location (step 104) for which a record is to be created or edited. The method may present a map interface to the user to facilitate selecting a location, and may automatically fill in geographical identity information (such as geographical coordinates) for the location upon selection (such as by tapping a location presented on the map interface). The operator may then enter location data (step 106) such as a title for the location, activation area for which messages are to be provided (which could differ for different types or categories of messages, and which may include only horizontal area definition or may include vertical position as well), type or category of location, etc. Note that this step may be skipped if the relevant information for the location has already been entered.

The operator may identify access conditions for a specific user group (step 108), such as a code or codes to be used to specify a user or group of users such that the messages contained within these records are only able to be accessed by specific users. The operator may create a message (step 110) for the location associated with the selected code or other access conditions attached, to allow the message for the location to be personalized for a particular group of users. The operator may then return to step 108 to select a different code, group of codes, or other access condition, and to create a message (step 110) for a different group or groups of users that correspond to that code. Data entry by the operator may be accomplished through a menu of prompts, such as by presenting the operator with one or more menus of options via an operator interface and allowing the operator to select from the options displayed.

Once the desired user-specific messages for a location have been entered, the operator may return to step 104 to select a new location, and entering any user-specific messages for that location (steps 108 and 110).

Once a message has been created and, optionally, reviewed, edited, and approved by the operator in step 110, the operator publishes (step 112) the new/updated record for the message. Alternatively, messages could be published as they are created before returning to a previous step to create a new message. Similarly, other steps could be performed in a different order, such as selecting an access group prior to selecting a location for a message to be provided to that access group, and/or creating a message before defining the access group for the message and/or the location for the message.

FIG. 1B illustrates one example of steps of routines that could be employed to perform the steps shown in method 100 for choosing a location (step 104) and for entering user-specific message data for that location (step 108). In the example illustrated, the operator upon gaining access (such as by logging in in step 102) is presented with a map display (step 130). The choice of location may be defined by the account of the operator, such as presenting a real estate operator with a map view of the city in which they operate. The operator then selects (step 132) a location displayed on the map, such as by tapping on the location (perhaps after using options to scroll, magnify, etc. to more precisely define the location). The geographical identity of the location (such as geographical grid coordinates) may be automatically loaded into the record based on the operator's selection.

Once the geographical identity of the location has been provided (step 132), the operator may be prompted (step 134) to create or edit a user-specific message record for that location. The operator enters access condition data for the user-specific message in step 136. (The operator may follow a similar process as described hereafter to edit information for user-specific messages previously created.) Such information typically includes the access information, such as code or codes, specifying the user or users that will have access to the particular message, which may include as many as all users of the mobile application.

Once the access conditions (and any other data relating to how the message should be considered) have been entered, the operator creates the message itself (step 138). However, the order of these steps is somewhat arbitrary, and the user could create the message (step 138) first and then subsequently enter information on the location (step 104) or the access conditions (step 136). For the case of an audio message, the user may perform step 138 by recording themselves speaking a message, or by entering text and having a voice message synthetically generated, such as by use of a generative AI capability. The operator may optionally be presented with the message for review (step 140), in which case the operator may be prompted to either approve or disapprove the message (step 142). If disapproved, the operator may be further allowed the option to recreate and/or edit the message, or to cancel the process (indicated by dashed line back to step 140, although the process could return to a different point). Once approved, the conditional message is updated in a message database (step 144), and may be published for presentation to users when appropriate (such as via publication step 112 shown in FIG. 1A).

FIG. 1C illustrates steps of a routine 150 for determining what location-based messages to provide to a particular user. While not illustrated, the routine may include one or more login steps similar to the operator step 102 to verify that the user is authorized to access the routine. To start, the current location of the user is determined in step 152. Such current location may be determined by a navigation application operating on a mobile device carried by the user that determines the location of such device via GPS signals, analysis of cellular transmitting towers, and/or other conventional techniques. Such location determination could be performed by an existing navigation/locating application and/or by a dedicated process. The current location of the user can then be compared to the activation areas for any locations associated with recorded messages to determine whether user is within activation area of a message location (step 154). In some cases, only horizontal position need be considered (for example, the activation area could be that the user is within a defined radius of the exact location), while in other cases the vertical position/elevation of the user may be considered, if the activation area has been defined with a vertical position. If no messages are identified, the current location continues to be monitored and compared to message locations. In the event that the user is determined in step 154 to be within the activation area of a message location, the record of messages for location is accessed (step 156) and for any user-specific messages, a determination is made (step 158) of whether the user has the appropriate access credentials matching any message for that location. If not, then the steps of the routine repeat, such as by return to step 152 of determining the user location. If the access condition of the user matches the condition for any user-specific message for the location, then the user is presented with the matching message (step 160). Such presentation may replace a “global” message that is available to all users (if any) for that location, or may present the user-specific message in combination with a “global” message (in which case, presenting the combined message can be considered as presenting the user-specific message). The steps of the routine then repeat, such as by return to step 152 of determining the user location.

FIG. 1D illustrates an alternative method 150′, which essentially combines the steps of determining location proximity (step 154 of method 150) and determining user access condition (step 158 of method 150). In the method 150′, after the location of the user is determined in step 152, the current location of the user is compared (step 154′) to the activation areas for any locations for any messages that match the access condition of that user. If no matching messages are identified, the current location continues to be monitored and compared to message locations. In the event that the user is determined in step 154′ to be within the activation area of a message location for a message that matches the access condition of the user, the record of matched messages for the location is accessed (step 156′) and the matching message is presented to the user in step 160.

FIG. 1E illustrates one example of a method 170 for defining and using access conditions, such as codes, for different groups of users to limit the users with access to such records. In the method 170 illustrated, the operator after accessing a system (step 102 shown in FIG. 1A) is provided the option of navigating to the portion of the content management system that generates codes, and is presented with an option to define a group of users (step 172). Upon defining a group, the operator may generate a code specific to that group (step 174), possibly by entering a specific series of characters or through random generation of characters. The operator may then assign or invite users to that group (step 176), such as by enter email addresses of the user to invite them to be a part of this group), thereby associating the group code to the user identities. The operator may then navigate to a map display to select a location (step 132) to create a message for that location (steps 134-144 shown in FIG. 1B), or may return to step 172 to define a different group and create access conditions for users of that group (steps 172-176).

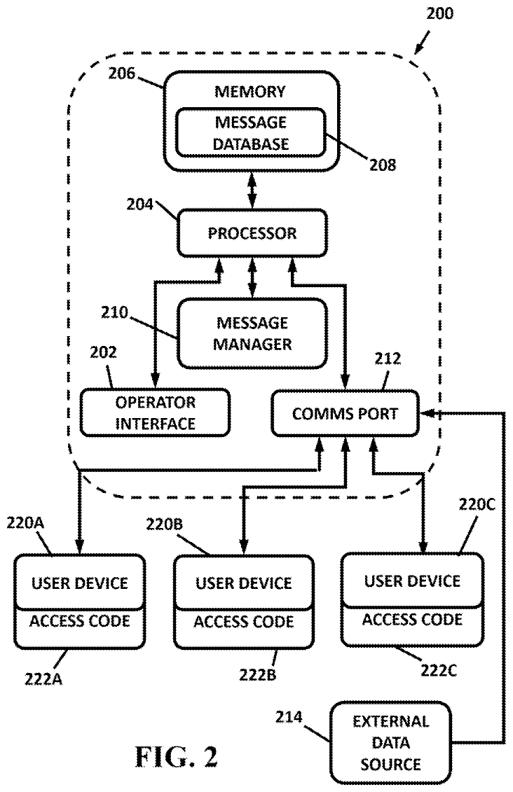

FIG. 2 is a block diagram showing one example of a system 200 that could be employed to perform methods such as discussed above. The system 200 includes an operator interface 202 that allows an operator to interact with a processor 204. The operator interface 202 and processor 204 can be provided by any conventional computing device, such as a desktop or laptop computer, smart phone, tablet, or other computing device. In many cases, the components of the system operate via instructions operating on a conventional computing device, and the operator interface allows the operator to enter data and commands to the processor 204, as well as displaying information from the processor 204 to the operator. The processor 204 can access a memory 206 that includes a message database 208 that stores message records (including related information such as location, activation area, access conditions, etc.) for a number of associated locations. A message manager 210 interacts with the processor 204 to allow the user to create message records for storage in the message database 208 and to determine when it is appropriate for a message to be presented to a particular end user.

A communications port 212 allows communications between the processor 204 and a number of end user devices (220A-220C). The user devices (220A-220C) are mobile devices such as smart phones and/or vehicle navigation systems that provide information for users, and typically include several features not illustrated (user interface, processor, memory, communications capability, location capability, etc.) The communications port 212 may also communicate with an external data source 214 that can provide the processor 204 (and thus the message manager 210 as well) with access to external information sources such as an external geographical information source (which can generate maps and identify the coordinates of selected locations), an external account/access management system (to limit access to authorized personnel), an external voice synthesis application (for converting text messages to audio), and/or any other external information source that may be helpful in performing the functions of the system 200.

Each user device (220A-220C) has an associated access code (222A-222C) accessible to the user device (220A-220C), for communication with the message manager 210 to allow the message manager 210 to provide only messages appropriate for the user associated with a particular user device (220A-220C). Thus, if a particular message has access conditions limited to the group containing the user of device 220A but not the users of devices 220B and 220C, the message manager 210 will match the code 222A with the access conditions for the message when the user of device 220A is within the location for such message, and will present such message to the user via device 220A. However, if the users of either device 220B or 220C is in the message location, they will not have access to the message if the access condition for the message does not match the access codes 222B or 222C (for a particular location, there may of may not be messages accessible to match either of these access codes).

It should be noted that some functions performed by components illustrated as part of the system 200 may be performed partially or entirely by software instructions running on the user devices (220A-220C) or other external capability. For example, the message database 208 could be stored on a number of servers that are accessed directly by the user devices (220A-220C), and the functions of the message manager 210 that relate to determining when a message should be presented could be performed by an application operating on the user device (220A-220C), responsive to a location/navigation application (an existing application and/or a dedicated application) that provides information on the location of the user. Alternatively, some or all of the message database 208 could be stored locally on the user devices (220A-220C) to allow the system to function without relying on communication between the user devices (220A-220C) and the communications port 212.

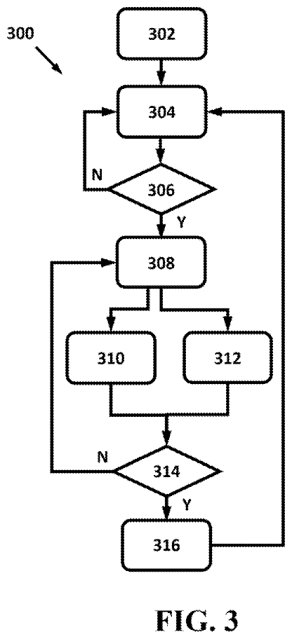

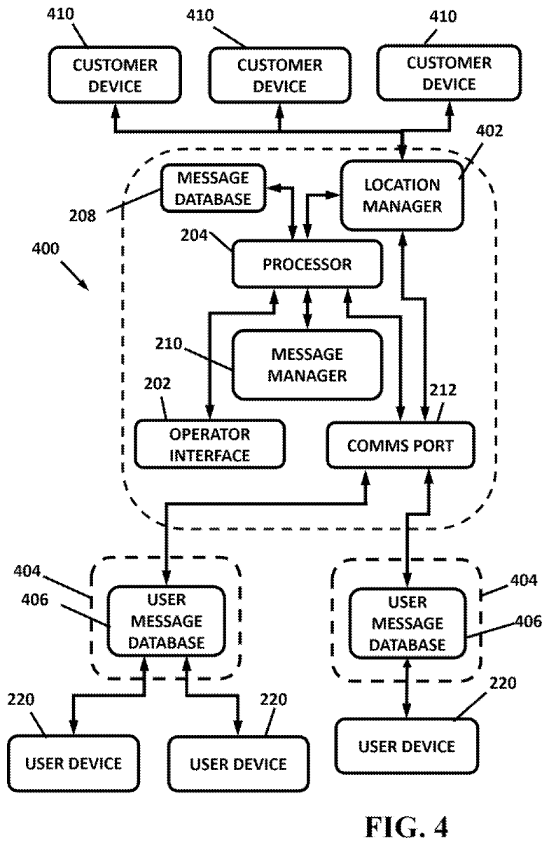

FIG. 3 shows an alternative method 300 for creating location-based messages for a location. The method 300 allows for a customer or other authorized person associated with a particular address to define a message for that address. This can allow, for example, a home owner, renter, or other authorized person to create a message with specialized delivery information to inform postal carriers and/or private company package delivery personnel (hereafter referred to simply as “users”) with any specific delivery information for the authorized person's address. Such information could include navigation directions to aid in reaching the correct address (such as where the street address may be confusing) and/or specific delivery information (such as a specific location to place packages). The method 300 may be performed by an application that allows individual authorized persons (hereafter simply referred to as “customers”) to define messages to be stored in a central database and made available to appropriate users. One example of a system for performing such method is shown in FIG. 4.

To begin creation of a location-based message, the method 300 allows a customer to log into an application (step 302) and select a location (step 304). The authorization of the customer to create a message for that location is then verified (step 306). Typically, authorization is only allowed for persons having a clear association with the particular location, such as a property owner or resident of the location. In some cases, the authorized person could have a different association, such as a real estate agent serving as the “customer” providing information on listed properties for potential buyers serving as “users”, or a construction company working on a site serving as a “customer” and providing information on the work site for deliveries of construction materials by “users”. As one alternative method, the method could be designed to initially match an authorized person with a location and then invite that person to create a message for the location. Once the customer has been authorized, they are prompted to define a message for the location (step 308). The defined message could be performed by allowing the customer to record an audio message (step 310) or by prompting them to enter a text message that is then used by a centralized system to generates an audio message (step 312). In either case, the customer may be allowed to review and approve the message (step 314) and, if desired, repeat the steps of defining (308) and creating (310 or 312) the message. Once the message is approved, it is then published to a database (step 316). The publishing step may include associating the message with an appropriate activation area and information on the location (the activation area and location information are typically handled by a central authority such as an operator as discussed above, and not accessible by the customer). The information can then be accessed by an appropriate user to provide the message to them when they are within the activation area of the location, in a manner such as discussed above for other methods.

FIG. 4 illustrates one example of a system 400 for allowing customers to define location-based messages for one or more locations with which they are associated. The system 400 incorporated many elements in common with the system 200 described above. The system 400 has a location manager 402 that manages the association of particular customers with locations for which they are authorized to create messages, such messages again being stored in a message database 208. The location manager 402 controls communication with a number of customer devices 410, each of which can serve to provide a customer interface for allowing a customer to define the message for a particular location, subject to them being authorized to do so. Such access could be provided via an application and/or website, and may be subject to an invitation sent by the system 400 via the location manager (typically communicating via the communications port 212). The location manager 402 may allow the user to define, and optionally create and/or review/approve the message via a method such as illustrated in FIG. 3, or by other appropriate method. The defined message for the location is then stored in the message database 208, where it is associated with an activation area, any other relevant location data, and optionally access condition information.

The system 400 communicates with at least one user manager 404, which represents an entity responsible for one or more users who are to be provided with messages when within the activation area of a location having an associated defined message. For example, when the messages contain detailed delivery information, the user managers 404 could each represent delivery entities such as the US Postal Service and/or private package delivery services such as United Parcel Service, Federal Express, DHL, Amazon, etc. The system may be designed to integrate seamlessly with existing information distribution systems that the user managers 404 utilize to communicate with users. The user managers 404 may include a user message database 406 that contains relevant information from the message database 208 (alternatively, the user manager 404 could be allowed access to relevant records stored in the message database 208). In some cases, the user manager may perform some functions of the location manager 402, such as by allowing customers who have an account with the user manager 404 to define a message for their address of record. The user manager 404 communicates with a number of user devices 220, providing users of such devices 220 with access to appropriate messages in the user message database 406 (which could be, at least partially, stored locally on the user device 220—for example, a user who is a route driver may have the messages matching all locations on their scheduled route or matching all locations having packages currently out for delivery loaded onto their user device 220 at the beginning of their shift before starting on their route).

Systems and methods such as described above can benefit from allowing users to provide feedback regarding the messages received. Such feedback can allow users to provide feedback regarding the message itself (such as the clarity, completeness, and/or appropriateness of the message) and/or feedback regarding a task related to the message (such as feedback regarding completion of a task). This can be especially beneficial for construction and other industries which rely on collaborative work on projects, such as fossil fuel extraction & refining, mining, utilities, aerospace, rail freight, etc. Such feedback can provide supervisors/managers with information regarding how effective their messaging is (including pointing out where adjustments could be made to improve the quality of future messages) and regarding the status of projects, user accountability for performing tasks related to messaging, and similar data. Feedback relating to a particular message and feedback may be analyzed to provide the user with feedback regarding their performance and/or with recommendations as to how to complete a task. Further benefit can be obtained when messages and their associated feedback are analyzed in aggregate, which may provide valuable insights for project management and/or aggregated data having value for research and/or AI training.

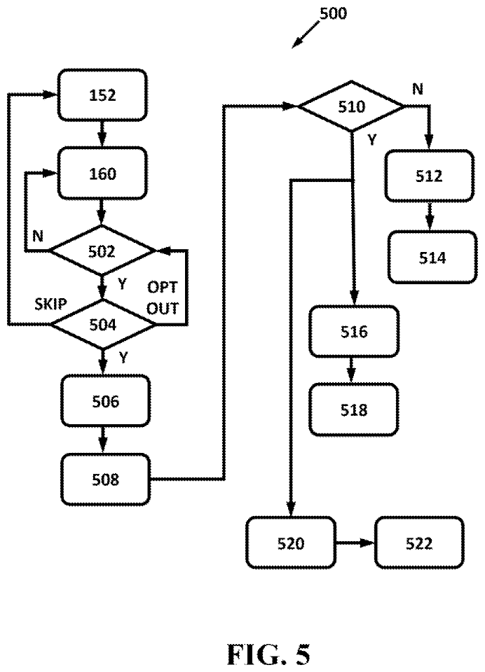

FIG. 5 illustrates one example of a method 500 for generating and processing feedback relating to a message that has been presented to a user (such as in step 160 of the method 150 or 150′ shown in FIGS. 1C & 1D) after determining (step 152) that the user is in an appropriate location to be presented with the message.

The method 500 begins with a determination (step 502) of whether to prompt the user for feedback. Such prompt could be provided every time a message is presented, or may be presented based on criteria (such as only prompting every so many messages, prompting based on past performance by the user, determining whether a user has opted out of prompts or otherwise should be exempt, etc.) Prompting may be made responsive to the user entering a checkpoint area defined with respect to a particular message, such as to assure that the user provides a status update as feedback for a message relating to a task to be performed. In some cases, the checkpoint area may be the inverse of the activation area, such that a user is presented the message upon entering the activation area, and prompted to provide feedback upon leaving the activation area. If no prompt is to be made, the method can return to the process until the next time a message is presented in step 160 (or could return to a different step of the process for presenting users with appropriate messages, such as step 152 of determining the user location). When a prompt is provided, the user may be offered the option (step 504) to provide feedback, to skip providing feedback, or in some cases the option to opt out of providing feedback. In the case of skipping the feedback, the method returns to some step of the process for presenting users with appropriate messages, such as step 152 (as with step 502, the process could return to a different step of the message-presenting process). The fact that the user skipped providing feedback could be logged, and could be considered in step 502 to determine whether to offer a prompt (for example, a user could be prompted after skipping one or more previous prompts, with the counter reset when the user does not skip). The option to opt out of prompts can set a flag for step 502 indicating that the user should not be prompted to provide feedback, at least for some period of time and/or number of messages presented. This option may only be available for certain groups of users.

Responsive to the prompt, the user may enter feedback in step 506. Such feedback could be entered as either a verbal or text feedback message, or could be entered via a graphic interface, such as by providing a numerical rating of message quality, by choosing selections from a menu of prompts, or other conventional forms of entry. If entered verbally, such as by recording audio of the user's verbal feedback, step 506 could include converting such audio to a text transcript. Alternatively, such conversion could be performed at a different step of the process. The feedback is then transmitted (step 508) to a centralized location, and may be subject to a validation check (step 510). The validation check step 510 may check to verify that the user is authorized to provide feedback. If the validation fails, an error may be logged (step 512) and a notice of such failure may be provided to the user (step 514). If the validation check 510 is passed, a record of the feedback and its associated message is stored (step 516) in a feedback database. The user ID may be stored as part of the record, but in some cases the records may be stored anonymously (such as for use in general analysis of aggregated feedback and messages). Confirmation that the feedback has been received can be sent to the user (step 518).

The feedback can be analyzed (step 520), either individually with its associated message, or in consideration with other feedback and/or messages stored in the feedback database. As an example of individual analysis, the feedback could be compared to the feedback to provide one-time immediate feedback to the user (step 522) regarding the message. Such immediate feedback could relate to the message itself (such as further information responsive to feedback indicating that the message is unclear, incomplete, and/or inappropriate), and/or could relate to a task that the message pertains to (such as comparing a user's summary of the task performed to the task as described in the message to point out successful completion or any discrepancies, and/or to provide recommendations to the user relating to how the task should be completed). Such immediate feedback could be based on analysis of the current message and feedback considered in relation to feedback stored for similar messages, such as to point out best practices, recognized safety issues, etc. based on the feedback of users who have performed similar tasks and/or have experience with the particular location. In some cases, the analysis may identify that a change to the message provided to appropriate users is warranted, and the step 522 of providing immediate feedback to the user could take the form of modifying the message for a particular group of users and notifying them of the updated message. For example, feedback from other users as to work accomplished, delivery status, conditions encountered, etc. may warrant a change in the instructions to other users at the relevant worksite. The original message to such user can be updated responsive to analysis of such conditions (as indicated by feedback and as analyzed by management personnel and/or by an AI capability) and presented to users at the location to provide immediate information updating their instructions as to how to proceed. Where such updates are provided by an AI capability, the updated message could be a computer-generated voice message, which may use AI to clone the voice of an operator associated with the original message (or other appropriate person). When such updates are provided via audio messages, they can notify users of changes in instructions without requiring them to actively access their messages. The updated message should also be available to users as they arrive at the relevant site.

The feedback database may store additional information, such as a record of messages for which a user did not provide feedback, a record of which users have opted out, and records regarding user behavior in providing feedback. The results of any analyses performed may be stored in the feedback database.

The contents of the feedback database can also be used for more general analysis purposes, which can be any analyses that look at multiple messages and feedback in aggregate. This may use records where a particular feedback and associated message are not tagged with the identity of the user who provided the feedback (“anonymized data”). In some cases, such records could be grouped according to other criteria, such as a general analysis of all records relating to a particular location, a particular task, or all records of feedback provided by a particular group of users, or of a single user over time. Even without further analysis, such feedback can provide a record of instructions and feedback on work done for review and/or accountability purposes, or to provide a record in the event of disputes. Such analyses may provide insights into evaluating performance of individual users and/or groups of users (such as all users associated with a particular subcontractor), improving operations (such as increasing efficiency, identifying areas of concern, and/or identifying aspects that are working well and should be reinforced and/or extended), and similar management information that can provide operational insights. Some information may be valuable in providing general industry insights (such as benchmarking, improving estimates, predictive analytics, etc.), for research purposes, and/or for use in training models generally falling under the category of artificial intelligence and/or machine learning.

The analysis step 520 may make use of artificial intelligence and/or machine learning models to provide one or more analyses suitable for an intended purpose. The feedback and associated message(s) may be processed using one or more appropriately trained models (Machine Learning Models, Large Language Models, Neural Networks, etc.) to information on performance and operations as needed for effective management. In turn, analyses provided in the step 520 could be provided as inputs to train AI capabilities, possibly in an iterative manner to improve future analyses.

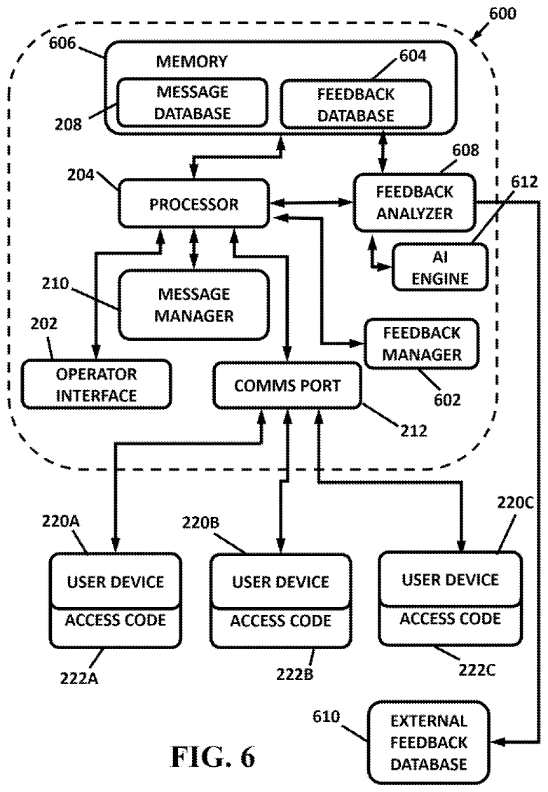

FIG. 6 illustrated one example of a system 600 for providing appropriate messages to users and receiving feedback from users on such messages. While illustrated as incorporating elements of the system 200 shown in FIG. 2, the particular components of the system 600 that are related to receiving and processing feedback could be applied to other systems for providing appropriate messages to users. As one example, elements of the system 600 could be used with a system such as the system 400 shown in FIG. 4, with a centralized processor 204 communicating with user managers 406 via appropriate application programming interfaces (API) to provide messages to users and to receive their feedback for analysis. The system 600 has a feedback manager 602 which coordinates with the processor 204 to provide prompts to enter feedback to users who have been presented with a message via communications port 212 and individual user devices 220. The feedback manager may control whether or not a prompt is provided in association with a particular message, using criteria such as discussed above for the method 500. When a user enters feedback via their user device 220, such feedback and the associated message can be stored in a feedback database 604, with is part of a memory 606.

A feedback analyzer 608 can access feedback and associated messages stored in the feedback database 604 and perform various analyses of such feedback. While shown accessing the feedback database 604 directly, in many cases such access would be via the processor 204. As discussed above regarding the method 500, the analysis could relate to a single feedback record (typically including the message associated with the feedback), and in such cases the analysis may provide information to the user who entered the feedback, to be presented via their user device 220. The feedback analyzer 608 may provide analysis information to an external feedback/analysis database 610, particularly for general analyses of multiple records. As noted regarding method step 520, the feedback analyzer may use an artificial intelligence engine 612 or other machine learning capability in performing some or all of the analysis. Employing an AI capability such as AI engine 612 to process feedback can generate actionable insights (e.g., identifying underperforming workers and/or subcontractors or predicting safety risks) in near real time, reducing delays in implementing operational improvements. This capability is particularly valuable for large-scale projects, where data-driven decisions can avoid costly errors or setbacks.

Methods and systems for providing appropriate messages and gathering feedback responsive to such messages can help address problems caused by miscommunication and unclear instructions, which are estimated to cost industries billions of dollars, and may cost lives where unsafe practices or conditions exist. In construction, for instance, complex blueprints, noisy sites, and fragmented teams may create errors such as misreading a spec, installing the wrong part, etc. Without real-time visibility, issues like shoddy welds or persistent delays may go unnoticed until they trigger rework, disputes, and penalties. A Prodoscore report pegs the cost of poor communication at $25,500 per employee annually for companies with over 100 workers. Autodesk and FMI studies estimate that bad communication and data mismanagement drive $31-$88 billion in yearly rework costs in construction alone-wasted on duplicated efforts, delays, and budget overruns.

This problem is further exacerbated when subcontractors are employed, who may have different protocols and norms for communication, and each of whom may be a potential weak link. General contractors frequently lack the tools to monitor subcontractor performance in real time. Problems fester undetected, leading to budget overruns and legal headaches. With the present methods and systems that collect and record feedback, the instructions and end-of-task feedback providing a synopsis of how things went can provide a permanent record for future review. If errors do show up, there is a permanent record of every instruction given by the subcontractor supervisors and how it was received. Such record can be incredibly valuable in determining who pays for a rework due to errors. Furthermore, analysis of feedback can help point out issues in need of being resolved before they cause serious problems.

The methods and systems can provide messages that act like a personal AI assistant for each user, slashing errors, boosting efficiency, and saving millions. Feedback collected can provide a record that a particular message was played, where it was played, and who it played to. The benefits of such methods and systems may be particularly beneficial for construction,. oil and gas production, mining, utilities, aerospace, package delivery, property management, and other sectors where precision and accountability matter.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that a certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method for managing location-based content, comprising the steps of:
creating a record for at least one location, such record for each location including a geographical identity of the location, an activation area, and at least one user-specific message for the location,
defining at least one access condition under which each user-specific message is to be activated for any user meeting the access condition; and
determining whether a user meeting the access condition is located within the activation area and, responsive to such determination, presenting the user with the message for that location corresponding to the appropriate access condition.

2. The method of claim 1 wherein, for at least one group of users, the access condition is that the user has access to a code associated with at least one message.

3. The method of claim 1 wherein, for a subset of messages, said step of defining at least one access condition further comprises setting the access condition for such messages such that the message is accessible by any user within the activation area.

4. The method of claim 1 wherein, for at least a subset of messages, the message has a user-specific code associated with it and the access condition includes the condition that a user within the activation area has access to the user-specific code for that message.

5. The method of claim 1 wherein the user-specific messages are audio messages and are created by at least one technique selected from the group of:
recording audio of an operator delivering the message; and
using a computer-generation capability to convert input entered by an operator into computer-generated audio.

6. The method of claim 1 further comprising the step of:
communicating the user-specific message to at least one user device,
wherein said step of determining whether a user meeting the access condition is located within the activation area is performed, at least in part, by the user device.

7. The method of claim 1 wherein, for at least one location, said step of creating a record includes creating at least two user-specific messages for the location; and
further wherein said step of defining at least one access condition includes defining an access condition for each of the user-specific messages, where at least two user-specific messages for the same location have different access conditions.

8. The method of claim 1 wherein said step of creating a record for at least one location further comprises the steps of:
for at least one location, identifying an authorized person associated with the location; and
prompting the authorized person to define at least one user-specific message for the location.

9. The method of claim 1 further comprising the steps of:
prompting at least one user who has been presented with a message to enter feedback regarding the message;
validating feedback entered by the user;
storing the validated feedback and associated message in a feedback database; and
analyzing the validated feedback and associated message to perform at least one step selected from the group of:
providing the user with immediate feedback regarding their performance of a task related to the associated message,
providing an evaluation of performance of the user regarding a task related to the associated message, and
aggregating feedback and associated messages to perform at least one general analysis regarding the aggregated feedback and associated messages.

10. The method of claim 9 wherein said step of analyzing the validated feedback and associated message is performed, at least partially, by an artificial intelligence capability, and generates at least one operational insight selected from the group of worker performance metrics and safety recommendations.

11. The method of claim 9 further comprising the steps of:
responsive to said step of analyzing the validated feedback and associated message, generating an update to at least one user-specific message; and
presenting the update to at least any user meeting the access condition for the message and located within the activation area.

12. The method of claim 9 wherein,
said step of creating a record for at least one location includes defining a checkpoint area for the location with respect to at least one user; and
wherein said step of prompting at least one user to enter feedback is performed responsive to determining when a particular user has entered their respective checkpoint area.

13. The method of claim 1 wherein the activation area is defined in terms of both horizontal and vertical position.

14. A storage medium comprising instructions that, when executed by a processing device, executes the method of claim 1.

15. A system for managing location-based content, the system comprising:
a message database;
at least one operator interface programmed to allow an operator to create a record in said message database for at least one location, such record for each location including geographical coordinates of the location, an activation area, at least one user-specific message for the location, and at least one access condition for each user-specific message;
at least one communication channel for communicating user-specific messages to at least user devices located within the activation area of any location associated with that user-specific message; and
a message manager programmed to determine whether the access condition for any user-specific message is currently met by a user located within the activation area and, responsive to such determination, presenting the user-specific message to such user(s) via user devices located within the activation area.

16. The system of claim 15 wherein, for a subset of messages, access condition for such messages is that they are accessible by any user within the activation area.

17. The system of claim 15 wherein, for at least a subset of messages, the message has a user-specific code associated with it and the access condition includes the condition that a user within the activation area has access to the user-specific code for that message.

18. The system of claim 15 wherein said message database stores the user-specific messages as audio messages and said operator interface is programmed to allow an operator to create such audio messages by at least one technique selected from the group of:
recording audio of an operator delivering the message; and
using a computer-generation capability to convert input entered by an operator into computer-generated audio.

19. The system of claim 15 wherein said message database and said message manager are provided, at least in part, by at least one application operating on a user device.

20. The system of claim 15 wherein said at least one operator interface is programmed to allow an operator to create at least one record in said message database for a single location, where such record includes and a different access condition for each of at least two user-specific messages.

21. The system of claim 15 wherein said at least one operator interface allows an operator to prompt at least one authorized person associated with a location to define at least one user-specific message for that location.

22. The system of claim 15 further comprising:
a feedback manager that prompts at least one user who has been presented with a message to enter feedback regarding the message and validates feedback entered by the user;
a feedback database that stores the validated feedback and associated message; and
a feedback analyzer that processes the validated feedback and associated message to provide at least one analysis product selected from the group of:
immediate feedback for the user with regarding their performance of a task related to the associated message,
an evaluation of performance of the user regarding a task related to the associated message, and
a general analysis of aggregated feedback and associated messages.

23. The system of claim 22 wherein said feedback analyzer is provided, at least in part, by an AI engine, and generates at least one operational insight selected from the group of worker performance metrics and safety recommendations.

24. The system of claim 22 wherein said feedback analyzer is configured to generate an update to at least one user-specific message for presentation to at least any user meeting the access condition for the message and located within the activation area.

25. The system of claim 22 wherein the record for at least one location includes definition of a checkpoint area for the location with respect to at least one user; and wherein said feedback manager prompts at least one user to enter feedback responsive to determining when that user has entered their respective checkpoint area.

26. The system of claim 15 wherein the activation area is defined in terms of both horizontal and vertical position.

27. A method for managing location-based content, comprising the steps of:
creating a record for at least one location, such record for each location including a geographical identity of the location and an activation area,
identifying an authorized person associated with the location, and
prompting the authorized person to define at least one message for the location;
determining whether an authorized user is located within the activation area for a location and, responsive to such determination, presenting the authorized user with the message for that location.

28. A system for managing location-based content, the system comprising:
a message database;
at least one customer interface that allows a customer, subject to authorization, to define a message for at least one location associated with that customer;
a location manager that controls authorization of the at least one customer interface and the association of each message with the at least one location associated with that customer, said location manager creating a record in said message database for the at least one location, such record for each location including geographical coordinates of the location, an activation area, and the message for the location defined via the associated customer interface;
at least one communication channel for communicating messages to at least user devices located within the activation area of any location associated with a defined message; and
a message manager programmed to determine whether a user is located within the activation area for any defined message and, responsive to such determination, presenting the defined message to such user(s) via user devices located within the activation area.
